(19) United States
(12) Patent Application Publication
(10) Pub. No.: US 2004/0264596 A1
(43) Pub. Date: Dec. 30, 2004

(54) Digital pre-distortion for the linearization of power amplifiers with asymmetrical characteristics

(75) Inventor: George P. Vella-Coleiro, Summit, NJ (US)

Correspondence Address: MENDELSOHN AND ASSOCIATES PC, 1515 MARKET STREET, SUITE 715, PHILADELPHIA, PA, 19102, US

(73) Assignee: Andrew Corporation, a Delaware corporation, Orland Park, IL

(21) Appl. No.: 10/607,924

(22) Filed: Jun. 27, 2003

(51) Int. Cl. H04K 1/02

(52) U.S. Cl. 375/297

(57) ABSTRACT

Pre-distortion, whose magnitude—and preferably phase—are frequency-dependent, is applied to an input signal in order to reduce spurious emissions resulting from subsequent amplification of the signal. In preferred embodiments, the pre-distortion technique of the present invention is implemented in combination with the (frequency-independent) magnitude and phase pre-distortion technique described in U.S. patent application Ser. No. 09/395,490 (“the '490 application”), where the frequency-dependent pre-distortion corresponds to amplifier distortion that has a magnitude that is proportional to the frequency offset from the carrier frequency and a phase shift of ±90° on either side of the carrier frequency. The frequency-dependent pre-distortion is generated by differentiating waveforms corresponding to two different sets of pre-distortion parameters with respect to time. One of the differentiated waveforms is applied to a positive-frequency filter and the other to a negative-frequency filter to generate positive- and negative-frequency pre-distortion signals, respectively, to account for asymmetries in the amplifier characteristics.

### CROSS-REFERENCE TO RELATED APPLICATIONS

The subject matter of this application is related to the subject matter of (a) U.S. patent application Ser. No. 09/395,490, filed on Sep. 14, 1999 as attorney docket number Johnson 6-1-17 (“the '490 application”), (b) U.S. patent application Ser. No. 10/068,343, filed on Feb. 5, 2002 as attorney docket number C0001, (c) U.S. patent application Ser. No. 10/153,446, filed on May 22, 2002 as attorney docket number C0008 (“the '446 application”), (d) U.S. patent application Ser. No. 10/153,289, filed on May 22, 2002 as attorney docket number C0009 (“the '289 application”), and (e) U.S. patent application Ser. No. 10/217,930, filed on Aug. 13, 2002 as attorney docket number C0015, the teachings of all five of which are incorporated herein by reference.

### FIELD OF THE INVENTION

The present invention relates to signal processing, and, in particular, to the pre-distortion of signals for transmission, for example, in a wireless communication network, to reduce spurious emissions.

### BACKGROUND OF THE INVENTION

Modern wireless communication networks employ complex modulation schemes that necessitate tight control of spurious emissions (sometimes called “out-of-band emissions”) in order to avoid interfering with neighboring carriers and to comply with the requirements of regulatory bodies (e.g., FCC) and standards bodies (e.g. ITU). One source of spurious emissions is the base station transmitter amplifier that is used to amplify signals prior to transmission as wireless (e.g., RF) signals to wireless (e.g., mobile) units in a wireless communication network, such as a cellular voice and/or data network. Prior art techniques for reducing such spurious emissions were able to satisfy previous requirements. However, recent developments in wireless communication networks (e.g., Universal Mobile Telecommunication Service (UMTS)) place additional burden on the base station transmitter amplifier and make it advantageous to reduce the spurious emissions even further.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a block diagram of a system, in accordance with the (frequency-independent) pre-distortion technique described in the U.S. application Ser. No. 09/395,490;

FIG. 2 shows a block diagram of the digital pre-distorter of FIG. 1;

FIG. 3 shows a block diagram of an exemplary FPGA implementation of the index calculating module, the delay block, the look-up table, and the output module of FIG. 2;

FIG. 4 shows a block diagram of an exemplary single-channel, single-conversion implementation of the receiver of FIG. 1; and

FIG. 5 shows a block diagram of a pre-distorter, according to one embodiment of the present invention.

FIGS. 6A-B show the real and imaginary components of the impulse response of a representative finite impulse response (FIR) filter that passes only the positive frequency components of a signal; and

FIGS. 7A-B show the real and imaginary components of the impulse response of a representative FIR filter that passes only the negative frequency components of a signal.

### DETAILED DESCRIPTION

Embodiments of the present invention are directed to techniques that reduce spurious emissions in wireless communication networks to levels that satisfy current requirements. In particular, embodiments of the present invention involve the application of pre-distortion to an input signal to generate a pre-distorted signal that, when applied, e.g., to an amplifier, results in lower spurious emissions in the resulting amplified signal, where the amplifier has asymmetrical characteristics (e.g., an asymmetry between spurious emissions that occur at frequencies below the center frequency and spurious emissions that occur at frequencies above the center frequency).

Pre-Distortion Technique of the '490 Application

The '490 application describes a technique for reducing spurious emissions using digital pre-distortion that was sufficient to meet previously existing regulations and standards. According to the '490 application, pre-distortion, whose magnitude and phase are frequency-independent, is applied to an input signal to generate a (main) pre-distorted signal that reduces spurious emissions when the pre-distorted signal is subsequently amplified by an amplifier. According to embodiments of the '289 and '446 applications, pre-distortion, whose magnitude—and preferably phase—are frequency-dependent, is applied to generate an additional (i.e., secondary) pre-distortion signal that, when combined with the main pre-distorted signal described in the '490 application, can further reduce spurious emissions in the amplified signal. The following section provides a description of the pre-distortion technique taught in the '490 application. Following that is a description of different possible implementations of a pre-distortion component, whose magnitude and phase are frequency-dependent, that is preferably combined with—but does not necessarily have to be combined with—the pre-distortion technique of the '490 application to further reduce spurious emissions in communications networks.

The pre-distortion technique described in the '490 application reduces adjacent channel power in wireless communication networks. In particular, the '490 application describes a technique for digitally and adaptively pre-distorting an outgoing signal that involves applying a correction to the signal before it is applied, e.g., to the input of a base station transmitter amplifier, such that the correction is equal and opposite to at least some of the anticipated distortion produced by the amplifier. The correction causes at least some of the amplifier distortion to be canceled, resulting in a base station transmitter having a more linear transfer characteristic than a corresponding transmitter without such pre-distortion. In these circumstances, the adjacent channel power (i.e., spurious emission) is desirably reduced.

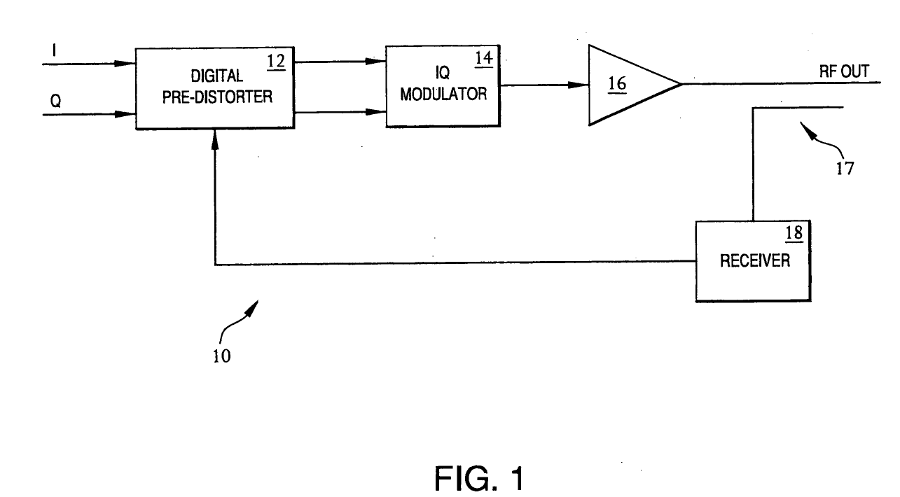

FIG. 1 shows a block diagram of a system 10, in accordance with the pre-distortion technique described in the '490 application. System 10 includes a digital pre-distorter 12 for receiving the in-phase (I) and quadrature (Q) components of an input digital baseband signal, an IQ modulator 14 connected to the output of pre-distorter 12, an amplifier 16 connected to the output of modulator 14, and a receiver 18 that is coupled to the output of amplifier 16 through a coupler 17 in order to generate a control signal that is fed back to pre-distorter 12. These components are configured to apply a correction to the input digital baseband signal (e.g., a code division multiple access (CDMA) signal, a wide-band CDMA signal, a time division multiple access (TDMA) signal, an enhanced data rates through global system for mobile communications evolution (EDGE) signal, or other signal, preferably with a substantially large peak power to average power ratio) generated by a communication device—such as a base station used for transmitting wireless communication data—and applied to pre-distorter 12 as the input signal (I, Q). System 10 also provides adaptive feedback through receiver 18 to optimize the correction.

More specifically, this pre-distortion technique comprises applying a correction to a digital baseband signal before the signal is applied to an input of amplifier 16 such that the correction is opposite to at least a portion of the distortion produced by amplifier 16. Thus, the correction and some portion of the amplifier distortion cancel one another, resulting in a system with a more linear transfer characteristic. In system 10, in order to take advantage of the precision and low cost of digital circuits, digital pre-distorter 12 preferably performs its correction at baseband, before the signal is converted by modulator 14 to radio frequency (RF) for amplification and transmission.

According to this pre-distortion technique, pre-distorter 12 pre-distorts both the magnitude and the phase of the input signal as a function of the signal power (but independent of frequency). Since both the magnitude and phase corrections vary with the instantaneous power (i.e., envelope power), pre-distorter 12 relies on accurate descriptions of the amplifier magnitude and phase variations with power level to perform its function. As will be described below, the functional representation of the corrections (versus power level) are in the form of polynomial equations from which a look-up table is preferably derived.

More particularly, the digital baseband signal is comprised of discrete time samples of in-phase (I) and quadrature (O) components which, after digital-to-analog conversion (not shown), are applied to the vector IQ modulator 14 to generate an RF signal that is then input to amplifier 16. Each sample for the baseband signal can be represented in complex number notation as (I+jQ), where j is the square root of (−1). The pre-distortion operation of pre-distorter 12 can be represented according to Equations (1)-(3) as follows:

I′+jQ′=(I+jQ)(A+jB) (1)

where

I′=IA−QB (2)

Q′=QA+IB (3)

where I′ and Q′ are the pre-distorted in-phase and quadrature baseband signals generated by pre-distorter 12, and A and B are pre-distortion parameters that are a function of the instantaneous envelope power of the input signal represented by I and Q. Conveniently, different values for parameters A and B may be stored in a look-up table (which is generated as described below) with the index being the instantaneous envelope power given by (I²+Q²).

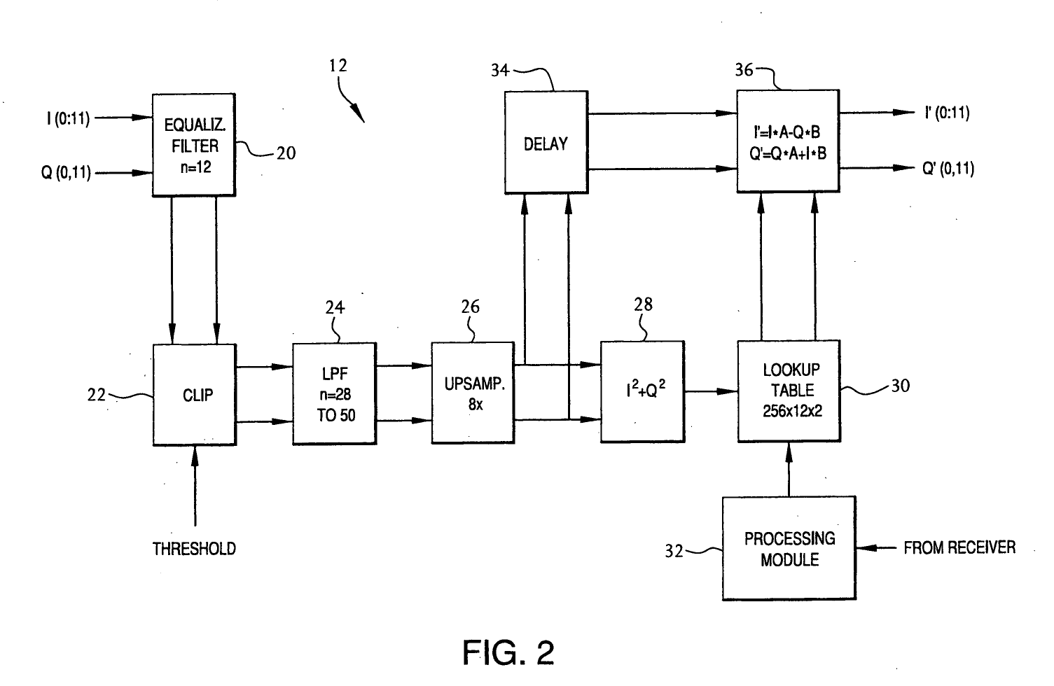

FIG. 2 shows a block diagram of digital pre-distorter 12 of FIG. 1, in accordance with the pre-distortion technique of the '490 application. As shown in FIG. 2, pre-distorter 12 includes an equalization filter 20 for receiving the signal that is comprised of the in-phase and quadrature components described above. The equalization filter is a component that is well known in the art and is operatively connected to a clipping module 22 that clips the signal to a predetermined threshold. The output of clipping module 22 is fed to a low-pass filter 24 that eliminates the high-frequency components that are generated during clipping.

The output of low-pass filter 24 is fed to a sampling module 26 that provides an up-sampled signal (e.g., increases the sampling rate by a factor of four from an original 2× rate to an 8× rate) to an index calculating module 28, which calculates an index value based on the sum of the squares of the in-phase and quadrature components of the baseband signal. Index calculating module 28 is connected to a look-up table 30 having stored therein parameters A and B. Values for parameters A and B are retrieved based on the calculated index value.

The pre-distortion parameters A and B of look-up table 30 are derived from a set of polynomial equations that closely approximate the corrections used to linearize the amplifier characteristics. Because of the complex nature of the characteristics of amplifiers, such as class AB amplifiers, advantageous results are obtained by using a pair of polynomial equations for parameter B, while a single polynomial equation is sufficient for parameter A. (As an approximation, it can be said that parameter A corrects the magnitude distortion of the amplifier, while parameter B corrects the phase distortion.) These polynomial equations can be written according to Equations (4)-(7) as follows:

A=C₀+C₁P+C₂P²+C₃P³ for A≦Aₘ (4)

A=Aₘ otherwise (5)

B=C₄P+C₅P²+C₆P³ for P≦P_{b} (6)

B=(B_{b1}−B_{b2})+C₇P+C₈P²+C₉P³ for P>P_{b} (7)

where P=(I²+Q²) is the instantaneous envelope power. Aₘ is a maximum value imposed on parameter A to prevent the amplifier from being driven deep into saturation. A typical value for Aₘ is 2, but it can vary depending on the detailed design. P_{b} is a breakpoint where parameter B transitions between Equations (6) and (7). P_{b} is an optimizable parameter whose value is obtained by the optimization algorithm. The value varies from amplifier to amplifier. It can also vary with temperature. B_{b1} and B_{b2} are the values of parameter B at P=P_{b} using Equations (6) and (7), respectively. The first term on the right-hand side of Equation (7) is intended to make Equations (6) and (7) continuous at P=P_{b}. C₀ through C₉ are coefficients that pertain to the transfer function characteristics of a particular amplifier and which can vary with temperature, aging of the amplifier components, etc. As with P_{b}, the optimization algorithm finds values for coefficients C₀ through C₉ that give optimized results.

Of course, it should be appreciated that, in appropriate circumstances, two polynomial equations may be used for parameter A as well as for parameter B. Furthermore, in many instances it is possible to reduce Equations (4) and (6) to exclude terms higher than the linear P term, resulting in Equations (4′)-(7′) as follows:

A=C₀+C₁P for P≦P_{b} (4′)

A=(A_{b1}−A_{b2})+C₂P+C₃P²+C₄P³ for P>P_{b} (5′)

B=C₅P for P≦P_{b} (6′)

B=(B_{b1}−B_{b2})+C₆P+C₇P²+C₈P³ for P>P_{b} (7′)

where A_{b1} and A_{b2} are the values of parameter A at P=P_{b} using Equations (4′) and (5′), respectively. As before, a maximum limit Aₘ can be placed on the value of parameter A. Also, if necessary, the breakpoint P_{b} where the transition is made from one polynomial equation to the other can have a different value for the A equations than for the B equations.

To accommodate the time-varying nature of the coefficients (e.g., C₀−C₉ in Equations (4)-(7)), an adaptive scheme is employed in this pre-distortion technique whereby the values of the coefficients are at least intermittently optimized (or operated on) to maintain minimum or reduced spurious emissions. Referring again to FIG. 1, coupler 17 at the output of amplifier 16 samples the output and receiver 18, which is tuned to the frequency region where the spurious emissions are to be reduced or minimized, generates a voltage proportional to the received power. Multiple receivers can be used to sample the spurious emissions at more than one frequency or a single receiver can tune sequentially to the different frequencies of interest. The voltages obtained at the different frequencies are then combined into a single quantity whose value is to be reduced or minimized. When two frequencies are used, which is generally sufficient, the resultant voltages, V₁ and V₂, can be combined according to Equation (8) as follows:

V=V₁+V₂+|(V₁−V₂)| (8)

where |(V₁−V₂)| is the absolute value of (V₁−V₂). Such use of an absolute value causes both V₁ and V₂ to be reduced or minimized, instead of simply providing the sum of the two values. If only the first two terms on the right-hand side of Equation (8) were used, the algorithm might find a false optimum by making one voltage very small and the other quite large. An alternative to Equation (8) is V=max (V₁, V₂), where max means choose the larger of the values.

A suitable algorithm to find the values of the coefficients that reduce or minimize V, and thus the spurious emissions, is the well-known simplex algorithm, described by Nelder and Mead in “A Simplex Method For Function Minimization,” Computer Journal, Vol. 7, pp. 308-3 13 (1965), which is incorporated herein by reference. As will be described below, the algorithm is implemented in modified form.

Referring again to FIG. 2, based on the feed-back signal from receiver 18 of FIG. 1, processing module 32 implements the modified simplex algorithm to update the values of parameters A and B stored in look-up table 30. It should be appreciated that processing module 32 may take a variety of forms such as a microprocessor, a digital signal processor, or a processing circuit using FPGA devices. It should be further appreciated that the simplex algorithm may be implemented in any suitable manner that utilizes appropriate combinations of hardware and software that will be apparent to those of skill in the art upon a reading hereof. Of course, the device used to implement the algorithm (here, module 32) should include suitable storage capacity to store and maintain the code and data necessary to run the algorithm.

At each iteration, the values of the coefficients derived by the algorithm are used in the equations for A and B described above to generate a table which is used by the algorithm for the next iteration. The algorithm is allowed to run continuously, or at least intermittently, so that the coefficient values track changes that occur over time.

The simplex optimization algorithm as developed by Nelder and Mead was intended for minimizing or reducing function values, which were obtained by mathematical computations. An important aspect of this mode of operation is that, if a computation is repeated, the same function value is obtained. This contrasts with values obtained by measurements on operating hardware where noise and fluctuations inevitably result in varying measured values. This difference has an important consequence when an attempt is made to use the simplex algorithm in real time on operating hardware.

The essence of the simplex algorithm is that, at each iteration, the set of coefficients that is associated with the worst function value is replaced with a new set which gives a better function value. This new value might or might not be better than the best function value obtained up to that time, but as the algorithm progresses it is expected that better and better function values will be obtained. Suppose that, as a result of noise and fluctuations in the measurements, an exceptionally good but erroneous value is obtained. If subsequent values obtained are all worse than this erroneous value, then the algorithm will converge on the erroneous value. Thus, in its conventional form, the algorithm is not very suitable for use in situations where considerable fluctuations exist in the quantity being optimized or operated on as may be in the present case.

To circumvent this difficulty, the simplex algorithm is used in modified form. At the end of each iteration, if the previous best value is replaced by a better value, then the algorithm proceeds to the next iteration. However, if an iteration does not yield a new best value, then the existing best point is re-evaluated and the new value is substituted for the previous one. Thus, the algorithm is able to recover from erroneous data due to fluctuating measurements. These fluctuations may result in a larger number of iterations in order to reach a desired point (which could be an optimum point), but will not prevent the desired point from being reached.

Another modification of the simplex algorithm enables it to operate continuously to track changes in amplifier characteristics caused by temperature changes, aging of components, or other disturbances. In the conventional implementation of the algorithm, an exit criterion is established (the criterion is usually related to the fractional variation of the function values between the worst and best points of the simplex) and the algorithm terminates when the criterion is satisfied. As the desired or optimum point is approached, the algorithm reduces the size of the simplex which typically becomes very small by the time the desired point is reached. Once this happens, the algorithm is no longer able to react to changes in amplifier characteristics.

In preferred implementations, the size of the simplex is prevented from becoming too small by comparing it to a value, such as a preset minimum value, at the start of each iteration and increasing the size to the value if it has been reduced below it. The value is chosen such that it is large enough to enable the algorithm to track changes in the amplifier characteristics but not so large that the desired (or optimum) point cannot be reached. A suitable value is one where the value of each coefficient at the worst point of the simplex differs from the corresponding value at the best point by 5 to 10 percent.

With continuing reference to FIG. 2, the output of sampling module 26 is also connected to a delay circuit 34, which is, in turn, connected to an output module 36 that generates an output signal based on the values of parameters A and B retrieved from look-up table 30 and the delayed upsampled signal from delay circuit 34. The delay applied by delay circuit 34 is preferably equivalent to the delay involved in performing the processing of modules 28 and 30 so that the appropriate values of (I and Q) and (A and B) arrive at output module 36 at the same time.

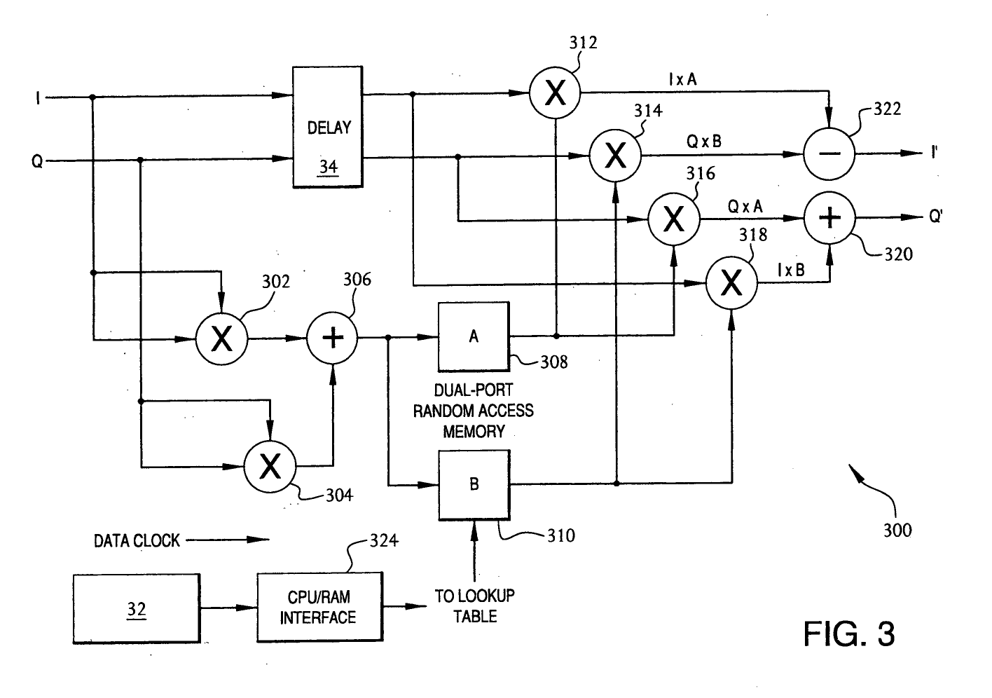

FIG. 3 shows a block diagram of an exemplary FPGA implementation 300 of index calculating module 28, delay 34, look-up table 30, and output module 36 of FIG. 2. The I and Q data paths are independently squared at multipliers 302 and 304 to create I² and Q², respectively. These two values are added together at adder block 306 to form an index address for look-up table 30, which, in FIG. 3, takes the form of two separate dual-port RAM memory blocks 308 and 310, which contain the parameters A and B, respectively. The parameters output from the memory blocks are multiplied by the delayed I and Q values at multipliers 312, 314, 316, and 318 to create the four values I×A, I×B, Q×A, and Q×B. These are combined by adder and subtractor blocks 320 and 322 to form (IA−QB) and (QA+IB), respectively, which are output as I′ and Q′.

Additional circuitry 324 loads the dual-port memory blocks 308 and 310 with parameter data generated in processing module 32 using standard memory interface signals. The use of dual-port memory permits real-time updating of the look-up tables without disrupting the accessing of parameter values by the pre-distortion process.

A look-up table configuration is not necessary where, for example, the processing module has a sufficiently high processing speed to allow for the obtaining of the A and B parameters on an “as needed” basis. In this case, the processing module calculates the appropriate coefficients and the A and B parameters are subsequently calculated by the processing module as needed or desired without storing such parameters in a look-up table.

Referring again to FIG. 1, receiver 18 in the digital pre-distortion adaptive feedback loop is used to measure the RF power over a narrow bandwidth at a specific frequency. This tuned frequency is offset from, for example, the main CDMA carrier frequency and is a frequency where the spurious emissions are to be minimized by the optimization algorithm.

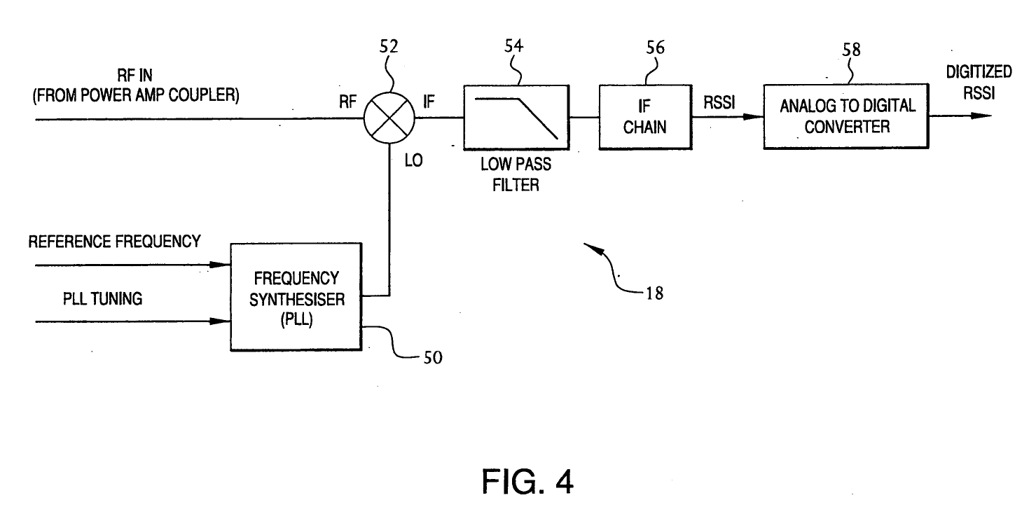

FIG. 4 shows a block diagram of an exemplary single-channel, single-conversion implementation of receiver 18 of FIG. 1. In this implementation, receiver 18 includes a frequency synthesizer 50, which is connected to a mixer 52. The output of mixer 52 is connected to a low-pass filter 54, which in turn is connected to an intermediate frequency (IF) chain 56. The output of IF chain 56 is connected to an analog-to-digital converter (ADC) 58, which then provides input to processing module 32 of FIG. 2. Three important frequencies in FIG. 4 are the RF frequency where the adjacent power level is to be measured, the local oscillator (LO) frequency which is varied as needed to tune the receiver, and intermediate frequency (IF) which is fixed. The LO frequency is found by LO=RF−IF.

More particularly, as shown in FIG. 1, the RF input of receiver 18 is coupled off the output of power amplifier 16 by coupler 17. This wide-band RF signal is down-converted to an intermediate frequency (IF) at mixer 52, where IF=RF−LO. The LO frequency for mixer 52 is generated by a phase-locked loop (PLL) frequency synthesizer 50. This LO frequency is set by (digital) tuning commands from a microprocessor (e.g., processing module 32 of FIG. 2).

Low-pass filter 54 is used to filter the RF+LO frequency products, as well as the RF and LO feed-through, and any higher frequency products produced by mixer 52. The receiver IF chain 56 is shown as a single block in FIG. 4. In one implementation, IF chain 56 actually includes amplifiers and a narrow bandpass filter, which assures that the power being measured is truly the power at the tuned frequency and does not contain power from, for example, the main CDMA carrier. IF chain 56 produces a Received Signal Strength Indicator (RSSI) voltage output that is proportional to the IF power, which in turn is proportional to the RF power. The RSSI voltage is sampled by ADC 58, where the resulting digitized RSSI is a digital word (which represents the power level at the tuned frequency) that is used by the optimization algorithm implemented by processing module 32 of FIG. 2.

In some implementations, the optimization algorithm monitors the spurious emissions at multiple frequency points, in which case, the single-channel receiver of FIG. 4 may be re-tuned for each different frequency. This re-tuning can be done with a procedure similar to the following:

A microprocessor (e.g., processing module 32) sends a tuning command to the frequency synthesizer to set the LO frequency (and therefore the receiver's tuned frequency).

The microprocessor waits for the PLL and RSSI to settle.

The digitized RSSI value is read by the microprocessor. Multiple readings could be taken if an average RSSI is used.

These steps are repeated for the next frequency.

The pre-distortion technique of the '490 application was designed to correct for at least some of the non-linearities of the amplifier by pre-distorting both the magnitude of the baseband signal (primarily achieved using the parameter A) as well as the phase (primarily achieved using the parameter B). There are, however, applications where the characteristics of the signal (ratio of peak power to average power close to 1, as in a single-channel TDMA system) do not allow substantial expansion of the magnitude so that the magnitude non-linearity of the amplifier cannot be corrected as fully as might be desired. In these applications substantial improvement can be obtained by correcting the phase as much as possible (via the parameter B) and correcting the magnitude partially by appropriate setting of the Aₘ value.

Frequency-Dependent Magnitude and Phase Pre-Distortion

As described in the previous section, the pre-distortion technique of the '490 application can be used to achieve a substantial reduction in spurious emissions, but it is frequently observed that some residual spurious emissions are still present. Attempts to reduce these residual spurious emissions by modifying the coefficients in Equations (4) to (7) (or in Equation (4′) to (7′)) result in an asymmetrical situation where a reduction in the spurious emissions on the low-frequency side of a communication channel are accompanied by an increase in the spurious emissions on the high-frequency side of the channel, and vice-versa, resulting in an overall degradation—or at least no overall improvement—in performance.

According to embodiments of the '289 and '446 applications, in order to reduce the spurious emissions to a level lower than that achieved by the (frequency-independent) pre-distortion technique of the '490 application, pre-distortion, whose magnitude and phase are frequency-dependent, is also applied.

The distortion caused by an amplifier can be considered to be made up of two parts. The first part, which is independent of the signal bandwidth and which is addressed by the '490 application (and other conventional frequency-independent pre-distortion techniques), is associated with the curvature of the amplifier's transfer function which leads to AM-AM (amplitude to amplitude) and AM-PM (amplitude to phase) type of distortions. The pre-distortion of the '490 application effectively deals with this part of the amplifier's distortion by correcting the curvature of the transfer function.

The second part of the amplifier distortion is negligible for narrow bandwidth signals, but it becomes increasingly important as the bandwidth increases. This part of the amplifier distortion has a magnitude that is proportional to the frequency offset from the carrier frequency and a phase shift of ±90° on either side of the carrier frequency. Since these characteristics match those of a differentiator, a correction of this part of the amplifier's distortion can be achieved using a differentiating filter circuit.

The combination of the two corrections can be expressed by Equation (9) as follows:

I′+jQ′=(I+jQ)(A+jB)+d{(I+jQ)(X+jY)}/dt (9)

where I and Q are the in-phase and quadrature components of the input signal before pre-distortion, I′ and Q′ are the corresponding components after pre-distortion, j is the square root of −1, and A, B, X, and Y, which are functions of the instantaneous power P(P=I²+Q²), are pre-distortion parameters. The symbol d/dt represents differentiation with respect to time. The first term on the right hand side of Equation (9) represents the bandwidth-independent part of the pre-distortion, while the second term represents the bandwidth-dependent part.

According to embodiments of the present invention, Equation (9) is replaced by Equation (10) as follows:

I′+jQ′=(I+jQ)(A+jB)+P[d{(I+jQ)(T+jU)}/dt]+N[d{(I+jQ)(V+jW)}/dt] (10)

where T, U, V, and W are functions of the power P, P represents an operation (e.g., a filter) that passes only the positive frequency components of the spectrum, and N represents an analogous operation that passes only the negative frequency components of the spectrum. (In this specification, positive and negative frequencies refer to the baseband representation of the signal. In non-baseband domains (e.g., RF), positive frequencies are greater than the center frequency, and negative frequencies are smaller than the center frequency.) By separating the positive frequencies from the negative frequencies and using different functions of the power P (i.e., T and U for the positive frequencies and V and W for the negative frequencies), it is possible to accommodate in a straightforward manner asymmetries in the amplifier characteristics that would otherwise be difficult to correct.

Depending on the implementation, the P and N operations can be accomplished in a variety of ways including using Fourier transforms, Hilbert transforms, or filters. Filters are the preferred implementation, since they are well suited for incorporation in an FPGA (field-programmable gate array) or ASIC (application-specific integrated circuit).

Frequency-Dependent Asymmetrical Magnitude and Phase Pre-Distortion in the Baseband Domain

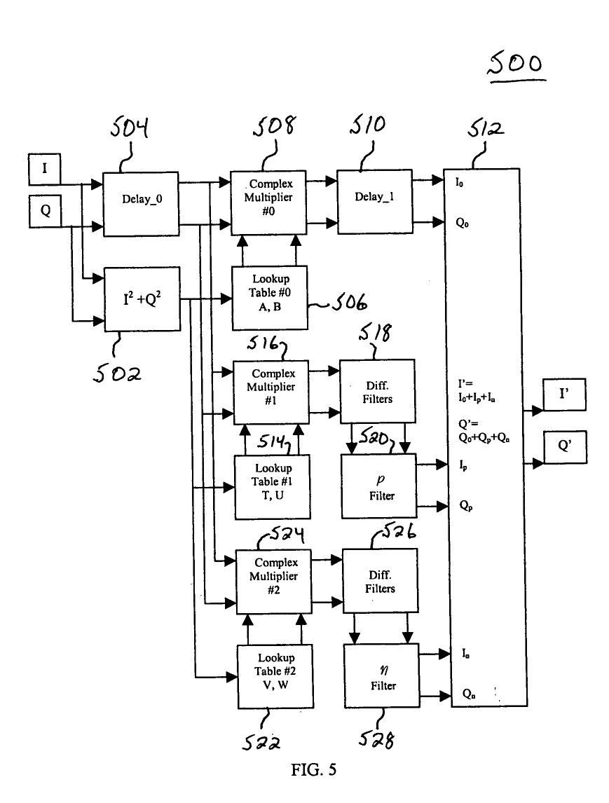

FIG. 5 shows a block diagram of a hardware (e.g., FPGA, ASIC, or DSP) implementation of a pre-distorter 500, according to one embodiment of the present invention. Pre-distorter 500 corresponds to an all-digital, baseband implementation of Equation (10). In accordance with Equation (10), pre-distorter 500 generates a main (frequency-independent) pre-distortion signal as described in the '490 application (corresponding to the first term on the right-hand side of Equation (10)) and two secondary pre-distortion signals (a positive-frequency pre-distortion signal corresponding to the second term on the right-hand side of Equation (10) and a negative-frequency pre-distortion signal corresponding to the third term on the right-hand side of Equation (10)), whose magnitudes and phases are frequency-dependent. The main pre-distortion signal and the two secondary pre-distortion signals are combined to generate a pre-distorted signal for application to an amplifier. In pre-distorter 500, pre-distortion is applied to a digital input signal in the baseband domain, where differentiation and filtering are performed in the digital domain.

In particular, copies of the digital, baseband input signals (I and Q) are applied to both index-calculating module 502 and delay block 504. Index-calculating module 502 generates the digital index signal (I²+Q²) (corresponding to the power of the input signal defined by I and Q), copies of which index are applied to lookup tables 506, 514, and 522. The values A and B retrieved from lookup table 506 are multiplied by the delayed I and Q data from delay block 504 in complex multiplier 508 to generate the first term on the right-hand side of Equation (10). This complex product is applied to delay block 510, and the resulting delayed product is applied to combiner 512.

The purpose of delay blocks 504 and 510 is to ensure synchronization between the different signal paths. In particular, delay block 504 compensates for the delay incurred in index-calculating block 502, while delay block 510 compensates for the delay introduced by differentiating filters 518 and 526 and P and N filters 520 and 528.

The values T and U retrieved from lookup table 514 are multiplied by the delayed I and Q data from delay block 504 in complex multiplier 516. The resulting complex product is applied to differentiating filter 518, which differentiates the complex product with respect to time. The resulting differentiated signals are applied to positive-frequency (P) filter 520, which passes only the positive frequency components to combiner 512. The signals from P filter 520 correspond to the second term on the right-hand side of Equation (10).

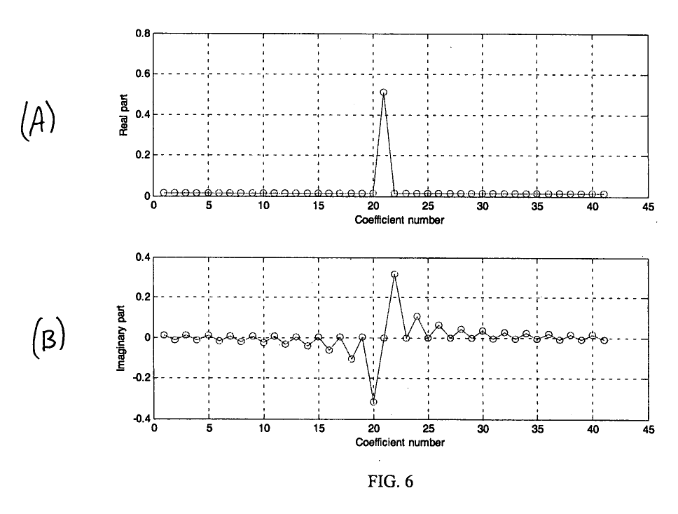

FIGS. 6A-B show the real and imaginary components of the impulse response of a representative finite impulse response (FIR) filter that passes only the positive frequency components of a signal. As such, P filter 520 can be implemented using an FIR filter based on the components of FIGS. 6A-B.

The values V and W retrieved from lookup table 522 are multiplied by the delayed I and Q data from delay block 504 in complex multiplier 524. The resulting complex product is applied to differentiating filter 526, which differentiates the complex product with respect to time. The resulting differentiated signals are applied to negative-frequency (N) filter 528, which passes only the negative frequency components to combiner 512. The signals from N filter 528 correspond to the third term on the right-hand side of Equation (10).

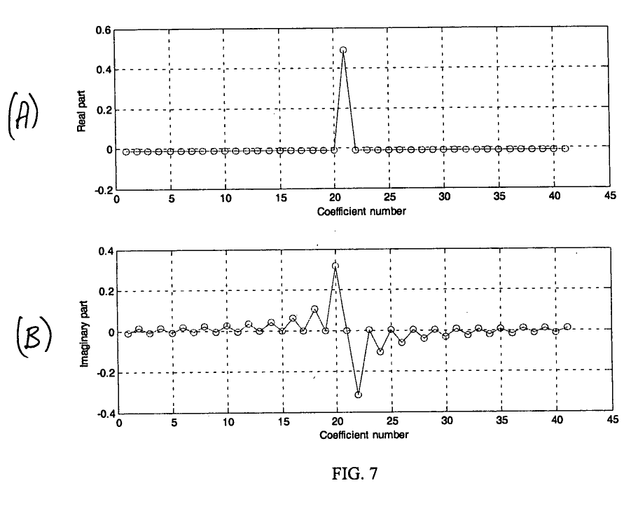

FIGS. 7A-B show the real and imaginary components of the impulse response of a representative FIR filter that passes only the negative frequency components of a signal. As such, N filter 528 can be implemented using an FIR filter based on the components of FIGS. 7A-B.

Combiner 512 combines the signals from delay block 510, P filter 520, and N filter 528 to form the digital, pre-distorted output signals (I′ and Q′). The digital, pre-distorted output signals (I′ and Q′) can be converted using DACs to analog signals that are then applied to a conventional IQ modulator to generate an IF or RF pre-distortion signal. Alternatively, the digital outputs (I′ and Q′) can be converted to a digital IF signal that is then up-converted to an RF signal after digital-to-analog conversion.

In the implementation shown in FIG. 5, the parameters A, B, T, U, V, and W are shown implemented as look-up tables. Alternatively, they can be evaluated in real time by computing the values of appropriate polynomials. In either case, the coefficients used to generate these parameters may be generated and adaptively updated using the simplex algorithm.

Although FIG. 5 shows differentiating filter 518 ahead of P filter 520 and differentiating filter 526 ahead of N filter 528, either of these orders could be reversed. Alternatively, either pair of filters 518 and 520 or 526 and 528 could be implemented as a single, combined filter.

Differentiating filters 518 and 526 can be implemented in a number of ways, as described in the '289 and '446 applications. A relatively simple implementation consists of a filter with just three coefficients: [0.5, 0, −0.5].

Alternative Embodiments

Depending on the particular application, the configuration shown in FIG. 5 can be implemented in the context of circuitry that includes modules analogous to equalization filter 20, clipping module 22, low-pass filter 24, and sampling module 26 of FIG. 2. In alternative implementations of the present invention, one or more—and even all—of these components may be omitted and/or one or more other processing components may be included, depending on the characteristics of the input signals and the requirements of the particular communication network.

Although the present invention has been described in the context of configurations in which frequency-dependent magnitude and phase pre-distortion of the present invention is combined with the (frequency-independent) magnitude and phase pre-distortion of the '490 application, the present invention is not so limited. In particular, it is possible to perform frequency-dependent magnitude and phase pre-distortion of the present invention without performing the pre-distortion of the '490 application. It is also possible to implement frequency-dependent magnitude pre-distortion without implementing frequency-dependent phase pre-distortion, with or without the frequency-independent pre-distortion of the '490 application.

Although the present invention has been described in the context of wireless signals transmitted from a base station to one or more mobile units of a wireless communication network, the present invention is not so limited. In theory, embodiments of the present invention could be implemented for wireless signals transmitted from a mobile unit to one or more base stations. The present invention can also be implemented in the context of other wireless and even wired communication networks to improve linearity.

Embodiments of the present invention may be implemented as circuit-based processes, including possible implementation on a single integrated circuit. As would be apparent to one skilled in the art, various functions of circuit elements may also be implemented as processing steps in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It will be further understood that various changes in the details, materials, and arrangements of the parts which have been described and illustrated in order to explain the nature of this invention may be made by those skilled in the art without departing from the scope of the invention as expressed in the following claims.

What is claimed is:

1. A method for reducing spurious emissions in an amplified signal by applying pre-distortion, whose magnitude is frequency-dependent, to an input signal to generate a pre-distorted signal, such that, when the pre-distorted signal is applied to an amplifier to generate the amplified signal, the pre-distortion reduces spurious emissions in the amplified signal, wherein the pre-distorted signal is generated by:
(a) generating a positive-frequency pre-distortion signal corresponding to positive-frequency components of the input signal;
(b) generating a negative-frequency pre-distortion signal corresponding to negative-frequency components of the input signal; and
(c) combining the positive- and negative-frequency pre-distortion signals to generate the pre-distorted signal.

2. The invention of claim 1, wherein the phase of the pre-distortion is also frequency-dependent.

3. The invention of claim 1, wherein:
the positive-frequency pre-distortion signal is generated by:
(1) generating a first set of one or more waveforms corresponding to a first set of one or more pre-distortion parameters;
(2) differentiating the first set of one or more waveforms with respect to time to generate a first set of one or more differentiated waveforms; and
(3) applying the first set of one or more differentiated waveforms to a positive-frequency operation to generate the positive-frequency pre-distortion signal; and
the negative-frequency pre-distortion signal is generated by:
(1) generating a second set of one or more waveforms corresponding to a second set of one or more pre-distortion parameters different from the first set of one or more pre-distortion signals;
(2) differentiating the second set of one or more waveforms with respect to time to generate a second set of one or more differentiated waveforms; and
(3) applying the second set of one or more differentiated waveforms to a negative-frequency operation to generate the negative-frequency pre-distortion signal.

4. The invention of claim 3, wherein the first and second sets of one or more pre-distortion parameters are retrieved from look-up tables using an index value based on a power level of the input signal.

5. The invention of claim 4, wherein the power level is a function of I²+Q², where the input signal is represented by I and Q signals.

6. The invention of claim 3, wherein the positive- and negative-frequency operations are implemented using filters.

7. The invention of claim 3, wherein:
the first set of one or more waveforms is differentiated before being applied to the positive-frequency operation; and
the second set of one or more waveforms is differentiated before being applied to the negative-frequency operation.

8. The invention of claim 1, further comprising the steps of:
generating a frequency-independent pre-distorted signal from the input signal; and
combining the frequency-independent pre-distorted signal and the positive- and negative-frequency pre-distortion signals to generate a combined pre-distorted signal.

9. The invention of claim 1, wherein:
the input signal is represented in a base-band domain; and
the positive- and negative-frequency pre-distortion signals are generated in a digital domain.

10. An apparatus for applying pre-distortion to an input signal to generate a pre-distorted signal, such that, when the pre-distorted signal is applied to an amplifier to generate an amplified signal, the pre-distortion reduces spurious emissions in the amplified signal, the apparatus comprising:
(a) a main signal processing path adapted to generate a main pre-distortion signal from the input signal;
(b) a positive-frequency secondary signal processing path adapted to generate a positive-frequency pre-distortion signal corresponding to positive-frequency components of the input signal;
(c) a negative-frequency secondary signal processing path adapted to generate a negative-frequency pre-distortion signal corresponding to negative-frequency components of the input signal; and
(d) a combiner adapted to combine the positive- and negative-frequency secondary pre-distortion signals with the main pre-distortion signal to generate the pre-distorted signal.

11. The invention of claim 10, wherein the phase of the pre-distortion is also frequency-dependent.

12. The invention of claim 10, wherein:
the main signal processing path is adapted to generate a frequency-independent pre-distorted signal from the input signal;
the positive-frequency secondary signal processing path is adapted to generate the positive-frequency pre-distortion signal by:
(1) generating a first set of one or more waveforms corresponding to a first set of one or more pre-distortion parameters;
(2) differentiating the first set of one or more waveforms with respect to time to generate a first set of one or more differentiated waveforms; and
(3) applying the first set of one or more differentiated waveforms to a positive-frequency operation to generate the positive-frequency pre-distortion signal; and
the negative-frequency secondary signal processing path is adapted to generate the negative-frequency pre-distortion signal by:
(1) generating a second set of one or more waveforms corresponding to a second set of one or more pre-distortion parameters different from the first set of one or more pre-distortion signals;
(2) differentiating the second set of one or more waveforms with respect to time to generate a second set of one or more differentiated waveforms; and
(3) applying the second set of one or more differentiated waveforms to a negative-frequency operation to generate the negative-frequency pre-distortion signal.

13. The invention of claim 12, wherein the first and second sets of one or more pre-distortion parameters are retrieved from look-up tables using an index value based on a power level of the input signal.

14. The invention of claim 13, wherein the power level is a function of I²+Q², where the input signal is represented by I and Q signals.

15. The invention of claim 12, wherein the positive- and negative-frequency operations are implemented using filters.

16. The invention of claim 12, wherein:
the first set of one or more waveforms is differentiated before being applied to the positive-frequency operation; and
the second set of one or more waveforms is differentiated before being applied to the negative-frequency operation.

17. The invention of claim 12, wherein:
the main signal processing path comprises:
(1) an index generator adapted to generate index values proportional to envelope power of the input signal; and
(2) a first look-up table adapted to provide first and second pre-distortion parameters using the index values;
the positive-frequency secondary signal processing path comprises:
(1) a second look-up table adapted to provide third and fourth pre-distortion parameters using the index values;
(2) a multiplier adapted to multiply the input signal by the third and fourth pre-distortion parameters to generate first multiplied signals;
(3) a differentiator adapted to differentiate the first multiplied signals with respect to time to generate first differentiated signals; and
(4) a positive-frequency filter adapted to filter the first differentiated signals; and
the negative-frequency secondary signal processing path comprises:
(1) a third look-up table adapted to provide fifth and sixth pre-distortion parameters using the index values;
(2) a multiplier adapted to multiply the input signal by the fifth and sixth pre-distortion parameters to generate second multiplied signals;
(3) a differentiator adapted to differentiate the second multiplied signals with respect to time to generate second differentiated signals; and
(4) a negative-frequency filter adapted to filter the second differentiated signals.

18. The invention of claim 10, wherein:
the input signal is represented in a base-band domain; and
the positive- and negative-frequency pre-distortion signals are generated in a digital domain.
